(19) United States
(12) Patent Application Publication
(10) Pub. No.: US 2014/0355816 A1
(43) Pub. Date: Dec. 4, 2014

(54) Microspeaker with Improved Soldering Structure

(71) Applicant: EM-TECH. Co., Ltd., Busan (KR)

(72) Inventor: In Ho Jeong, Changwon-si (KR)

(21) Appl. No.: 14/287,675

(22) Filed: May 27, 2014

(30) Foreign Application Priority Data
May 28, 2013 (KR) 10-2013-0060074

(51) Int. Cl. H04R 31/00; H04R 1/00

(52) U.S. Cl. CPC H04R 31/006; H04R 1/00
USPC 381/433

(57) ABSTRACT

A microspeaker is provided with a soldering structure which can overcome a process defect or a progressive defect during the soldering of a terminal pad and a suspension. A sound transducer has a frame, a magnetic circuit, a voice coil and a diaphragm, the microspeaker with an improved soldering structure, and including: a suspension guiding a vibrating direction of the diaphragm and the voice coil, made of a conductive material to apply electrical signals to the voice coil, and having a through hole at its corners; and a terminal pad secured to the frame, one end of which is brought into contact with a terminal outside of the sound transducer, the other end of which passes through the through hole of the suspension.

### PRIORITY CLAIM

The present application claims priority to Korean Patent Application No. 10-2013-0060074 filed on 28 May 2013, the content of said application incorporated herein by reference in its entirety.

### TECHNICAL FIELD

The present invention relates to a microspeaker with an improved soldering structure. In more particular, the present invention relates to a microspeaker with an improved soldering structure of a terminal pad insert injection-molded into a frame and a suspension made of an FPCB.

### BACKGROUND

FIG. 1 is an exploded perspective view showing a conventional microspeaker, and FIG. 2 is a sectional view showing the conventional microspeaker. In the conventional microspeaker, a yoke 21, an inner magnet 22, an outer ring magnet 23, an inner ring top plate 24 and an outer ring top plate 25 are disposed in a frame 10, and a voice coil 30 is disposed in an air gap between the inner magnet 22 and the outer ring magnet 23 and vibrates vertically when power is applied to the voice coil 30. The voice coil 30 is mounted on the bottom surface of a suspension 50, and a side diaphragm 41 and a center diaphragm 42 are disposed on the top and bottom surfaces of the suspension 50 and vibrate together with the vibration of the voice coil 30 to produce a sound. A protector 60 is coupled to the top of the suspension 50 to protect all the components located inside the speaker. The protector 60 includes a ring-shaped steel portion 61 with an opening 63 at the center to emit a sound, and a ring-shaped injection portion 62 into which the steel portion 61 is inserted injection-molded and which is stacked on the frame 10, the outer peripheral portion of the side diaphragm 41, and the outer peripheral portion of the suspension 50.

In order to enable power to be supplied from the outside to the voice coil 30, there is a terminal pad 70 attached to the bottom of the frame 10 to provide a connection point with an external terminal. The terminal pad 70 is inserted during the injection molding of the frame 10 and coupled to the frame 10 by the insert injection molding.

FIG. 3 is a view showing a conventional soldering structure of a terminal pad and a suspension made of an FPCB. The suspension 50 is provided by attaching conductive patterns (not shown), which serve to transfer electrical signals, to the top and bottom surfaces of a base film 51, and by attaching top and bottom surface cover layers 52 and 53 to the conductive patterns (not shown) for protection purposes. While attached to the top of the frame 10 (see FIGS. 1 and 2) by a double-sided tape 54 or a bond, the suspension 50 is soldered to the terminal pad 70. Tin-plated portions 55 and 56 are provided on land portions of the suspension 50 to enhance conductivity during the soldering. While the suspension 50 is fixedly attached using the double-sided tape 54, the terminal pad 70 and the suspension 50 are soldered by melting a lead-free solder 2 using a soldering iron 1.

FIG. 4 is a view showing a soldering defect which occurs in the soldering structure of FIG. 3. In this conventional soldering structure, the terminal pad 70 and the bottom surface of the suspension 50 are spaced apart from each other by the total thickness of the bottom surface cover layer 53 of the suspension 50 and the double-sided tape 54. As the terminal pad 70 and the suspension 50 are spaced apart, a process defect may possibly occur that the lead-free solder 2 is attached to the suspension 50 but not attached to the terminal pad 70, or a progressive defect may possibly occur that the lead-free solder 2 is detached from the terminal pad 70 during the use of a final product.

### SUMMARY

An object of the present invention is to provide a microspeaker with a soldering structure which can overcome a process defect or a progressive defect during the soldering of a terminal pad and a suspension.

According to an aspect of the present invention, there is provided a microspeaker having a frame, a magnetic circuit, a voice coil and a diaphragm, the microspeaker with an improved soldering structure, including: a suspension guiding a vibrating direction of the diaphragm and the voice coil, made of a conductive material to apply electrical signals to the voice coil, and having a land portion for soldering at its corners, the land portion having a through hole; and a terminal pad secured to the frame, one end of which being brought into contact with a terminal outside of the sound transducer, the other end of which passing through the through hole of the suspension.

In addition, the terminal pad is insert injection-molded into the frame, a protruding portion passing through the through hole of the suspension being exposed to the outside of the frame.

Moreover, the protruding portion of the terminal pad is formed by bending an end of the terminal pad.

Further, a solder covers the protruding portion of the terminal pad and the periphery of the through hole on the top surface of the suspension.

Furthermore, a tin-plated portion is further provided on the periphery of the through hole of the land portion.

The sound transducer with the improved soldering structure as disclosed in the present invention can remarkably eliminate the possibilities of the process defect or the progressive defect by removing a gap between components to be soldered, i.e., between the suspension and the terminal pad.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is an exploded perspective view showing a conventional microspeaker.

FIG. 2 is a sectional view showing the conventional microspeaker.

FIG. 3 is a view showing a conventional soldering structure of a terminal pad and a suspension made of an FPCB.

FIG. 4 is a view showing a soldering defect which occurs in the soldering structure of FIG. 3.

FIG. 5 is an exploded perspective view showing a microspeaker with an improved soldering structure according to an embodiment of the present invention.

FIG. 6 is a view showing a suspension provided in the microspeaker with the improved soldering structure according to the embodiment of the present invention.

FIG. 7 is a view showing a terminal pad provided in the microspeaker with the improved soldering structure according to the embodiment of the present invention.

FIG. 8 is a perspective view showing the microspeaker with the improved soldering structure according to the embodiment of the present invention.

FIG. 9 is a sectional view showing the microspeaker with the improved soldering structure according to the embodiment of the present invention.

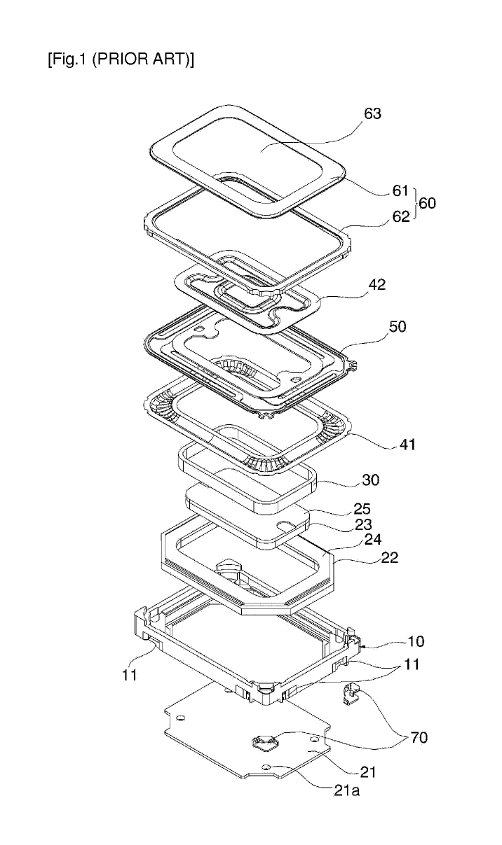

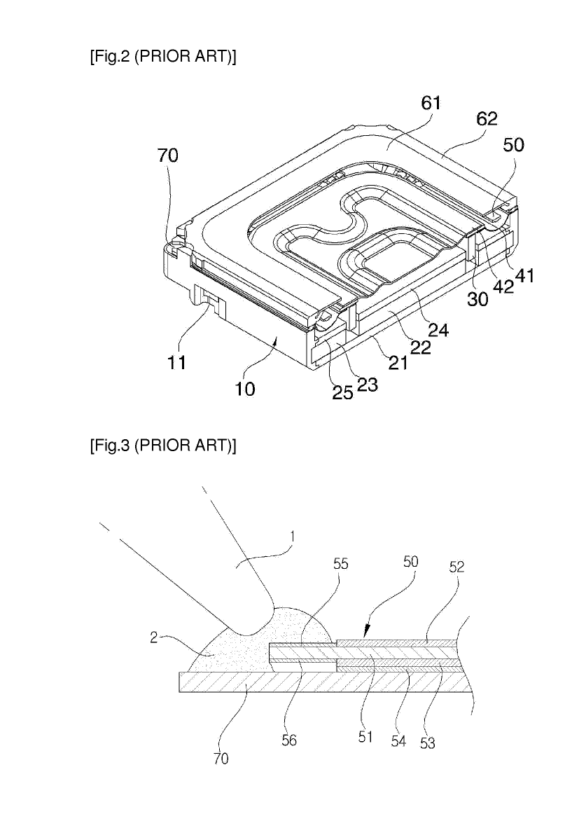

### DETAILED DESCRIPTION

Hereinafter, the present invention will be described in more detail with reference to the drawings.

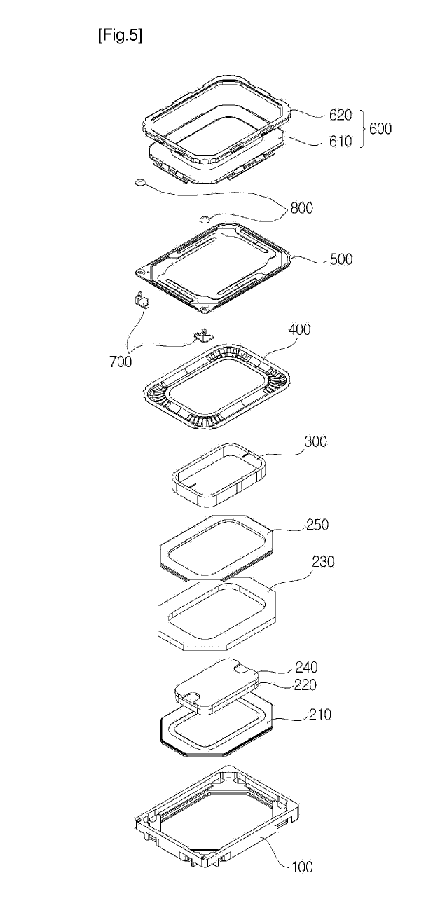

FIG. 5 is an exploded perspective view showing a microspeaker with an improved soldering structure according to an embodiment of the present invention. The microspeaker according to the embodiment of the present invention includes a frame 100, a magnetic circuit disposed in the frame 100, a vibrating body vibrating due to a mutual electromagnetic force with the magnetic circuit, a protector 600 coupled to the top of the frame 100 to protect the magnetic circuit and the vibrating body, a terminal pad 700 insert injection-molded into the frame 100, and a solder 800 electrically connecting the terminal pad 700 to a suspension discussed later by soldering.

The magnetic circuit includes a yoke 210 coupled to the frame 100, an inner magnet 220 attached to the top of the yoke 210, an outer ring magnet 230 attached to the top of the yoke 210 with a certain gap from the inner magnet 220, an inner ring top plate 240 covering the inner magnet 220 and assisting in forming a magnetic flux, and an outer ring top plate 250 covering the outer ring magnet 230 and assisting in forming a magnetic flux. The gap between the inner magnet 220 and the outer ring magnet 230 is also called an air gap. A lower end of a voice coil of the vibrating body discussed later is disposed in this air gap. When a current flows through the voice coil, the voice coil vibrates vertically due to the mutual electromagnetic force with the magnetic circuit.

The vibrating body is composed of a voice coil 300, a diaphragm 400, and a suspension 500. As described above, when an electrical signal is applied to the voice coil 300, the voice coil vibrates due to the mutual electromagnetic force with the magnetic circuit. Here, the suspension 500 guides the voice coil 300 to vibrate only in the vertical direction. The voice coil 300 and the diaphragm 400 are attached to the suspension 500, and the diaphragm 400 vibrates together with the vibration of the voice coil 300 to produce a sound.

In order to protect the magnetic circuit and the vibrating body, a protector 600 is coupled to the frame 100. The protector 600 is composed of a steel portion 610 for providing rigidity and an injection portion 620 for preventing a short of the suspension 500 and the terminal pad 700.

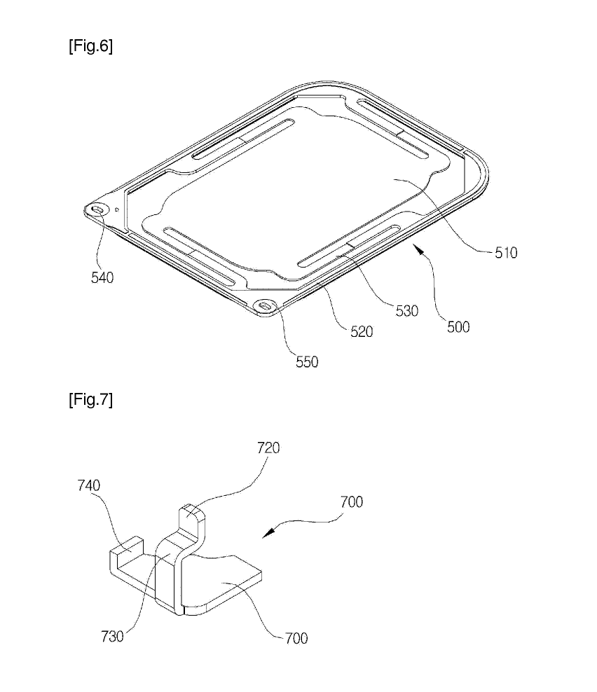

FIG. 6 is a view showing the suspension provided in the microspeaker with the improved soldering structure according to the embodiment of the present invention.

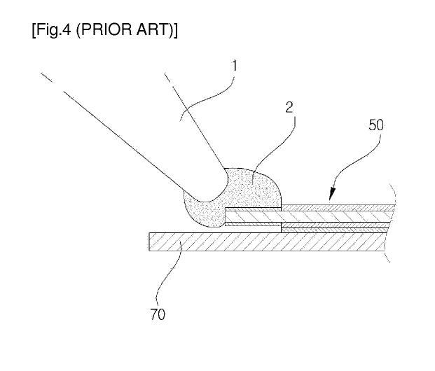

The suspension 500 is made of an FPCB to transfer electrical signals to the voice coil 300. Referring again to FIGS. 3 and 4, a conductive film is patterned on a base film, and a cover layer is attached thereto.

The suspension 500 generally includes a center portion 510 to which the voice coil 300 is attached, a ring-shaped outer peripheral portion 520 disposed with a certain gap from the center portion 510, and a connecting portion 530 connecting the center portion 510 to the outer peripheral portion 520 and performing a damping function.

A pair of land portions 540 and 550 are provided at the neighboring corners of the suspension 500 for soldering to the terminal pad 700, while a pair of land portions (not shown) are provided inside the suspension 500 for soldering to a lead wire of the voice coil 300. Each of the land portions 540 and 550 includes a through hole 540 and a tin-plated portion 550 disposed on the periphery of the through hole 540. A protruding portion of the terminal pad 700 discussed later passes through the through hole 540, and the tin-plated portion 550 serves to enhance conductivity and adhesiveness of the solder. The tin-plated portion 550 can be electrically connected to the conductive pattern to transfer electrical signals, which were received through the terminal pad 700, to the voice coil 300.

FIG. 7 is a view showing the terminal pad provided in the microspeaker with the improved soldering structure according to the embodiment of the present invention. The terminal pad 700 provided in the microspeaker with the improved soldering structure according to the embodiment of the present invention includes a contact portion 710 exposed to the bottom surface of the frame 100 (see FIG. 5) and brought into contact with an external terminal, a protruding portion 720 exposed to the top of the frame 100 in a protruding manner and passing through the through hole 540 (see FIG. 6) of the suspension 500 (see FIG. 6), and a connecting portion 730 connecting the contact portion 710 to the protruding portion 720 and embedded in an injection material of the frame 100 (see FIG. 5) during the injection molding of the frame 100 (see FIG. 5).

The connecting portion 730 is bent from the contact portion 710 and extended to the top of the frame 100, then bent again and extended in a horizontal direction to a position of the through hole 540 (see FIG. 6). The protruding portion 720 is upwardly bent from the end of the connecting portion 730, is exposed to the outside of the frame 100, and protrudes through the through hole 540 (see FIG. 6).

Meanwhile, it is preferable that a bent portion 740, which is upwardly bent from at least one side of the contact portion 710 and inserted into the frame injection material, should be further provided such that the contact portion 710 can be stably secured to the frame 100.

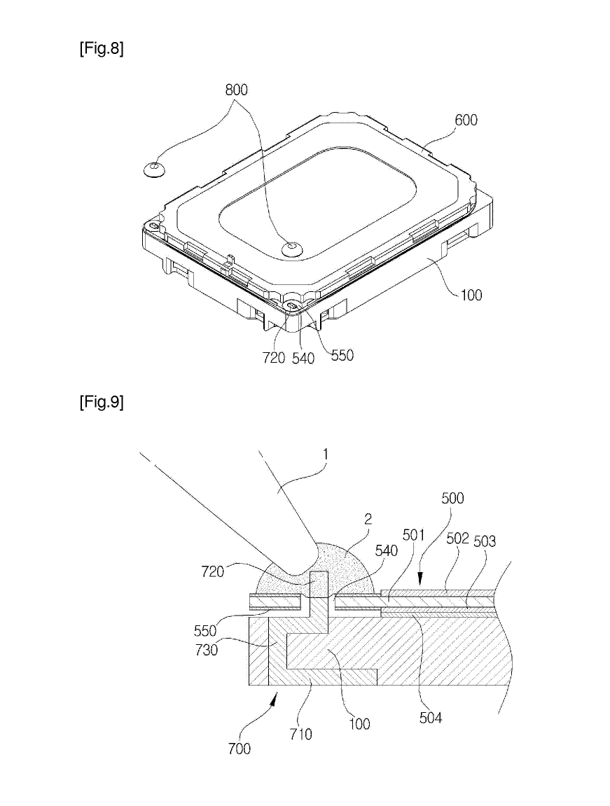

FIG. 8 is a perspective view showing the microspeaker with the improved soldering structure according to the embodiment of the present invention, and FIG. 9 is a sectional view showing the microspeaker with the improved soldering structure according to the embodiment of the present invention. The protruding portion 720 of the terminal pad 700 protrudes to the top of the frame 100 and exposes itself through the through hole 540 of the suspension 500. A lead-free solder 2 is molten, using a soldering iron 1, to cover the protruding portion 720 and the periphery of the through hole 540. A tin-plated portion 550 is provided on the periphery of the through hole 540 to improve conductivity and adhesiveness of the solder.

The suspension 500 is provided by attaching conductive patterns (not shown), which serve to transfer electrical signals, to the top and bottom surfaces of a base film 501, and by attaching top and bottom surface cover layers 502 and 503 to the conductive patterns (not shown) for protection purposes. While attached to the top of the frame 100 by a double-sided tape 504 or a bond, the suspension 500 is soldered to the terminal pad 700.

While the suspension 500 is fixedly attached using the double-sided tape 504, the terminal pad 700 and the suspension 500 are soldered by melting the lead-free solder 2 using the soldering iron 1. According to the present invention, the lead-free solder 2 is soldered to cover the land portion 540 and 550 of the suspension 500 and the protruding portion 720 of the terminal pad 700, which can remarkably eliminate the possibilities of the process defect or the progressive defect caused by the gap between the suspension 500 and the terminal pad 700 in the prior art.

Spatially relative terms such as “under”, “below”, “lower”, “over”, “upper” and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising” and the like are open-ended terms that indicate the presence of stated elements or features, but do not preclude additional elements or features. The articles “a”, “an” and “the” are intended to include the plural as well as the singular, unless the context clearly indicates otherwise.

With the above range of variations and applications in mind, it should be understood that the present invention is not limited by the foregoing description, nor is it limited by the accompanying drawings. Instead, the present invention is limited only by the following claims and their legal equivalents.

What is claimed is:

1. A sound transducer having a frame, a magnetic circuit, a voice coil and a diaphragm, the microspeaker with a soldering structure, comprising:
a suspension guiding a vibrating direction of the diaphragm and the voice coil, made of a conductive material to apply electrical signals to the voice coil, and having a land portion for soldering at its corners, the land portion having a through hole; and
a terminal pad secured to the frame, one end of which is brought into contact with a terminal outside of the sound transducer, the other end of which passes through the through hole of the suspension.

2. The microspeaker of claim 1, wherein the terminal pad is insert injection-molded into the frame and comprises a protruding portion passing through the through hole of the suspension being exposed to the outside of the frame.

3. The microspeaker of claim 2, wherein the protruding portion of the terminal pad is formed by bending an end of the terminal pad.

4. The microspeaker of claim 2, wherein a solder covers the protruding portion of the terminal pad and a periphery of the through hole on a top surface of the suspension.

5. The microspeaker of claim 1, wherein a tin-plated portion is further provided on a periphery of the through hole of the land portion.
